(19) United States
(12) Patent Application Publication
(10) Pub. No.: US 2016/0309516 A1
(43) Pub. Date: Oct. 20, 2016

(54) POWER REDUCTION ON RANDOM ACCESS RESPONSE RECEPTION FOR COVERAGE ENHANCED LOW COMPLEXITY MACHINE TYPE COMMUNICATION

(71) Applicants: Shin Horng WONG, Chippenham (GB); Sigen YE, New Providence, NJ (US); Seau Sian LIM, Swindon (GB); David BHATOOLAUL, Swindon (GB)

(72) Inventors: Shin Horng WONG, Chippenham (GB); Sigen YE, New Providence, NJ (US); Seau Sian LIM, Swindon (GB); David BHATOOLAUL, Swindon (GB)

(21) Appl. No.: 14/690,443

(22) Filed: Apr. 19, 2015

(51) Int. Cl. H04W 74/08; H04W 74/00

(52) U.S. Cl. CPC H04W 74/0833; H04W 74/006

(57) ABSTRACT

A user equipment includes a processing circuit and a transceiver connected to the processing circuit. The processing circuit is configured to: determine whether to decode a random access response message received by the user equipment based on downlink control information received by the user equipment over a physical downlink control channel, the downlink control information one of implicitly and explicitly indicating whether the random access response message is intended for the user equipment; and decode the random access response message to obtain a random access response for the user equipment if the downlink control information indicates that the random access response message is intended for the user equipment. The transceiver is configured to establish a radio resource connection based on the obtained random access response.

### BACKGROUND

A Machine Type Communication (MTC) device is a user equipment (UE) that is used by a machine for specific application. In 3^{rd} Generation Partnership Project Long Term Evolution (3GPP-LTE) Release 12 (Rel-12), a work item (WI) on Low Complexity MTC (LC-MTC) UEs was concluded in which the complexity and cost of MTC UEs were reduced by approximately 50%. In Release 13 (Rel-13), another WI was agreed upon to further reduce complexity, enhance coverage and improve power consumption of MTC UEs.

One complexity and cost reduction technique is to reduce the radio-frequency (RF) bandwidth of LC-MTC UEs to 1.4 MHz (operating with 6 Physical Resource Blocks (PRBs), where a PRB is a unit of resource allocation in the frequency domain).

For a coverage enhancement (CE) aspect of this WI, one technique for reducing complexity and cost is repetition of the physical channel. However, it is expected that the number of repetitions will be relatively high (e.g., hundreds of repetitions), which may have an impact on spectra efficiency.

### SUMMARY

One or more example embodiments may reduce power consumed by user equipments (UEs), such as Low Complexity Machine Type Communication (LC-MTC) UEs, when receiving random access responses (RARs) in coverage enhanced and/or non-coverage enhanced modes with a configured random access (RA) response window. One or more example embodiments may also reduce complexity, cost and/or enhance coverage of LC-MTC UEs.

At least one example embodiment provides a user equipment including a processing circuit and a transceiver connected to the processing circuit. The processing circuit is configured to: determine whether to decode a random access response message received by the user equipment based on downlink control information received by the user equipment over a physical downlink control channel, the downlink control information one of implicitly and explicitly indicating whether the random access response message is intended for the user equipment; and decode the random access response message to obtain a random access response for the user equipment if the downlink control information indicates that the random access response message is intended for the user equipment. The a transceiver is configured to establish a radio resource connection based on the obtained random access response.

At least one other example embodiment provides a user equipment including a processing circuit and a transceiver connected to the processing circuit. The processing circuit is configured to: detect a preamble message on a physical downlink shared channel based on downlink control information received by the user equipment over a physical downlink control channel; determine whether a random access response message on the physical downlink shared channel is intended for the user equipment based on the detected preamble message; and decode the random access response message to obtain a random access response for the user equipment if the detected preamble message indicates that that the random access response message is intended for the user equipment. The transceiver is configured to establish a radio resource connection based on the obtained random access response.

According to at least some example embodiments, the downlink control information one of implicitly and explicitly indicates whether the preamble message is present on the physical downlink shared channel

At least one other example embodiment provides a base station comprising a transceiver. The transceiver is configured to transmit downlink control information to a user equipment on a physical downlink control channel in response to preamble information received from the user equipment, the downlink control information being indicative of whether a random access response message transmitted to the user equipment on a physical downlink shared channel is intended for the user equipment, the transceiver being further configured to transmit the random access response message to the user equipment on the physical downlink shared channel.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 illustrates a 3^{rd} Generation Partnership Project Long-Term Evolution (3GPP LTE) network.

FIG. 2 illustrates an example eNodeB (eNB).

FIG. 3 illustrates an example embodiment of a user equipment (UE).

FIG. 4 is a signal flow diagram illustrating a method for establishing a radio resource control (RRC) connection between a UE and an eNB, according to an example embodiment.

FIG. 5 illustrates an example embodiment of Random Access CHannel (RACH) transmissions for coverage enhanced (CE) UEs.

FIG. 6 is a flow chart illustrating an example embodiment of a method for processing Random Access Response (RAR) messages received at a UE in a random access (RA) response window.

FIG. 7 is a flow chart illustrating another example embodiment of a method for processing RAR messages received at a UE in a RA response window.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

While example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing small wireless cells, base stations, NodeBs, user equipments (UEs) including LC-MTC UEs, etc. Such existing hardware may include one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “eNodeB” or “eNB” may be considered synonymous to, and may hereafter be occasionally referred to as a NodeB, base station, transceiver station, base transceiver station (BTS), macro cell, etc., and describes a device in communication with and providing wireless resources to UEs in a geographical coverage area. As discussed herein, eNBs may have all functionally associated with conventional, well-known base stations in addition to the capability and functionality discussed herein.

As used herein, the term “small wireless cell” may be considered synonymous to, and may hereafter be occasionally referred to as a micro cell, pico cell, Home NodeB (HNB), Home eNodeB (HeNB), etc., and describes a device in communication with and providing wireless resources (e.g., LTE, 3G, WiFi, etc.) to users in a geographical coverage area that is, in most cases, smaller than the geographical coverage area covered by a macro eNB or cell. As discussed herein, small wireless cells may have all functionally associated with conventional, well-known base stations in addition to the capability and functionality discussed herein. In this regard, the small wireless cells may include a base station or eNB. Small wireless cells according to at least some example embodiments may also serve as WLAN (or WiFi) access points (APs) providing WLAN (or WiFi) resources for devices within range of the small wireless cell. Although discussed with regard to macro eNBs, example embodiments may also be applicable to small wireless cells and base stations.

Generally, as discussed herein, a small wireless cell may be any well-known small wireless cell including one or more processors, various communication interfaces (e.g., LTE, WiFi and wired), a computer readable medium, memories, etc. The one or more interfaces may be configured to transmit/receive data signals via wireless connections over a WiFi and a cellular network to/from one or more other devices, and also communicate with the Internet, for example over a wired connection.

The term “user equipment” or “UE”, as discussed herein, may be considered synonymous to, and may hereafter be occasionally referred to, as user, client, client device, mobile unit, mobile station, mobile user, mobile, subscriber, user, remote station, access terminal, receiver, etc., and describes a remote user of wireless resources in a wireless communication network (e.g., a 3^{rd} Generation Partnership Project Long-Term Evolution (3GPP LTE) network). The UEs discussed herein may be low complexity machine type communication (LC-MTC) UEs capable of operating in coverage enhanced (CE) and/or non-coverage enhanced (non-CE) modes.

According to example embodiments, UEs, small wireless base stations (or cells), eNBs, etc. may be (or include) hardware, firmware, hardware executing software, or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs), computers, or the like, configured as special purpose machines to perform the functions described herein as well as any other well-known functions of these elements. In at least some cases, CPUs, SOCs, DSPs, ASICs and FPGAs may collectively be referred to as processing circuits, processors and/or microprocessors.

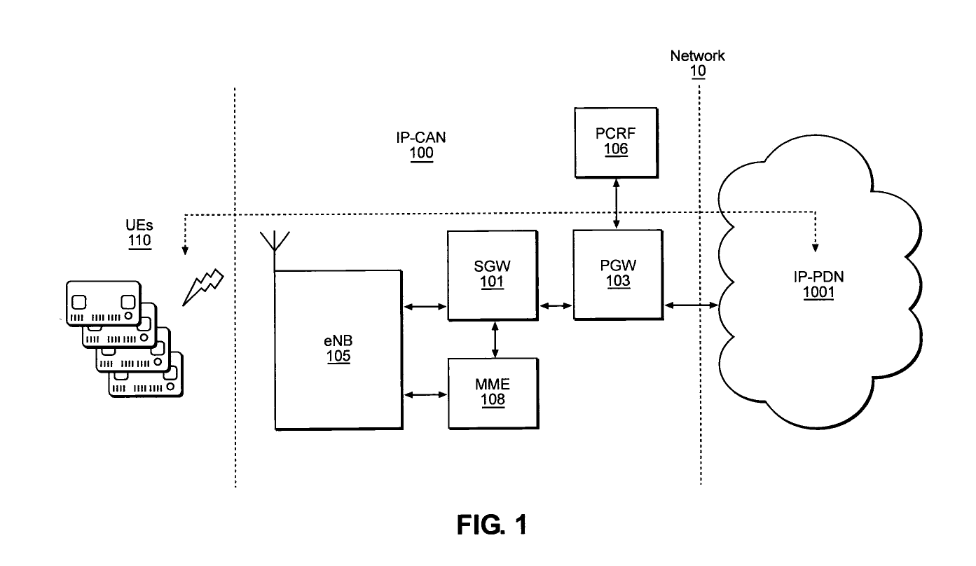

FIG. 1 illustrates a 3GPP LTE network 10.

Referring to FIG. 1, the network 10 includes an Internet Protocol (IP) Connectivity Access Network (IP-CAN) 100 and an IP Packet Data Network (IP-PDN) 1001. The IP-CAN 100 includes: a serving gateway (SGW) 101; a packet data network (PDN) gateway (PGW) 103; a policy and charging rules function (PCRF) 106; a mobility management entity (MME) 108 and eNode B (eNB) 105. Although not shown in FIG. 1, the IP-PDN 1001 portion of an evolved packet system (EPS) may include application and/or proxy servers, media servers, email servers, etc.

Within the IP-CAN 100, the eNB 105 is part of what is referred to as an Evolved Universal Mobile Telecommunications System (UMTS) Terrestrial Radio Access Network (EUTRAN), and the portion of the IP-CAN 100 including the SGW 101, the PGW 103, the PCRF 106, and the MME 108 is referred to as the Evolved Packet Core (EPC). Although only a single eNB 105 is shown in FIG. 1, it should be understood that the EUTRAN may include any number of eNBs. Similarly, although only a single SGW, PGW and MME are shown in FIG. 1, it should be understood that the EPC may include any number of these core network elements.

Still referring to FIG. 1, the eNB 105 provides wireless resources and radio coverage for one or more user equipments (UEs) 110. That is to say, any number of UEs 110 may be connected (or attached) to the eNB 105 to access wireless network services and resources. The eNB 105 is operatively coupled to the SGW 101 and the MME 108. Additional functionality of the eNB 105 and the UEs 110 will be discussed in more detail later.

The SGW 101 routes and forwards user data packets, while also acting as the mobility anchor for the user plane during inter-eNB handovers of UEs. The SGW 101 also acts as the anchor for mobility between 3GPP LTE and other 3GPP technologies. For idle UEs, the SGW 101 terminates the downlink data path and triggers paging when downlink data arrives for the idle UEs.

The PGW 103 provides connectivity between the UEs 110 and external packet data networks (e.g., the IP-PDN) by serving as the point of entry/exit of traffic for the UEs 110 to/from the IP-CAN 100. As is known, a given UE 110 may have simultaneous connectivity with more than one PGW 103 for accessing multiple PDNs.

Still referring to FIG. 1, eNB 105 is also operatively coupled to the MME 108. The MME 108 is the control-node for the EUTRAN, and is responsible for idle mode UE 110 paging and tagging procedures including retransmissions. The MME 108 is also responsible for choosing a particular SGW for a UE during initial attachment of the UE to the network, and during intra-LTE handover involving Core Network (CN) node relocation. The MME 108 authenticates UEs 110 by interacting with a Home Subscriber Server (HSS), which is not shown in FIG. 1.

Non Access Stratum (NAS) signaling terminates at the MME 108, and is responsible for generation and allocation of temporary identities for UEs 110. The MME 108 also checks the authorization of a UE 110 to camp on a service provider's Public Land Mobile Network (PLMN), and enforces UE 110 roaming restrictions. The MME 108 is the termination point in the network for ciphering/integrity protection for NAS signaling, and handles security key management.

The MME 108 also provides control plane functionality for mobility between LTE and 2G/3G access networks with an S3 type of interface from the SGSN (not shown) terminating at the MME 108.

Still referring to FIG. 1, the Policy and Charging Rules Function (PCRF) 106 is the entity that makes policy decisions and sets charging rules. It has access to subscriber databases and plays a role in the 3GPP architecture.

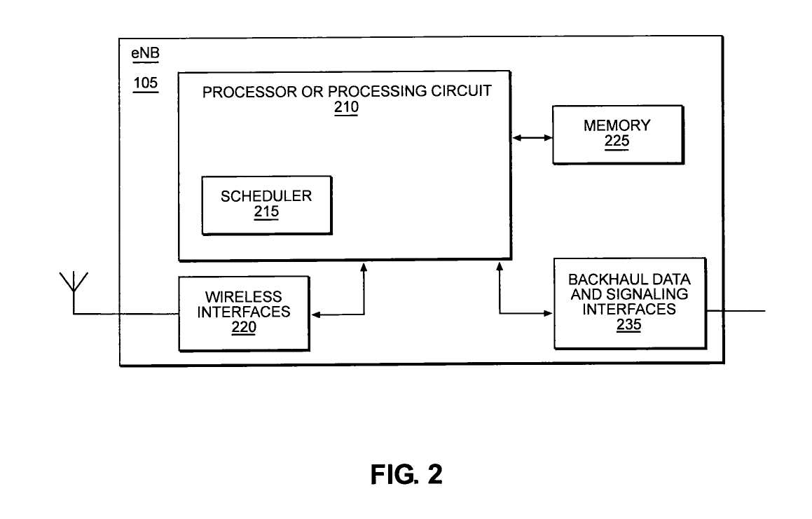

FIG. 2 illustrates an example of the eNB 105 shown in FIG. 1.

Referring to FIG. 2, the eNB 105 includes: a memory 225; a processor 210; a scheduler 215; wireless communication interfaces 220; and a backhaul data and signaling interfaces (referred to herein as backhaul interface) 235. The processor or processing circuit 210 controls the function of eNB 105 (as described herein), and is operatively coupled to the memory 225 and the communication interfaces 220. While only one processor 210 is shown in FIG. 2, it should be understood that multiple processors may be included in a typical eNB, such as the eNB 105. The functions performed by the processor may be implemented using hardware. As discussed above, such hardware may include one or more Central Processing Units (CPUs), digital signal processors (DSPs), application-specific-integrated-circuits, field programmable gate arrays (FPGAs) computers or the like. The term processor or processing circuit, used throughout this document, may refer to any of these example implementations, though the term is not limited to these examples.

Still referring to FIG. 2, the wireless communication interfaces 220 (also referred to as communication interfaces 220) include various interfaces including one or more transmitters/receivers (or transceivers) connected to one or more antennas to wirelessly transmit/receive control and data signals to/from the UEs 110, or via a control plane.

The backhaul interface 235 interfaces with the SGW 101, MME 108, other eNBs, or other EPC network elements and/or RAN elements within IP-CAN 100.

The memory 225 may buffer and store data that is being processed at eNB 105, transmitted and received to and from eNB 105.

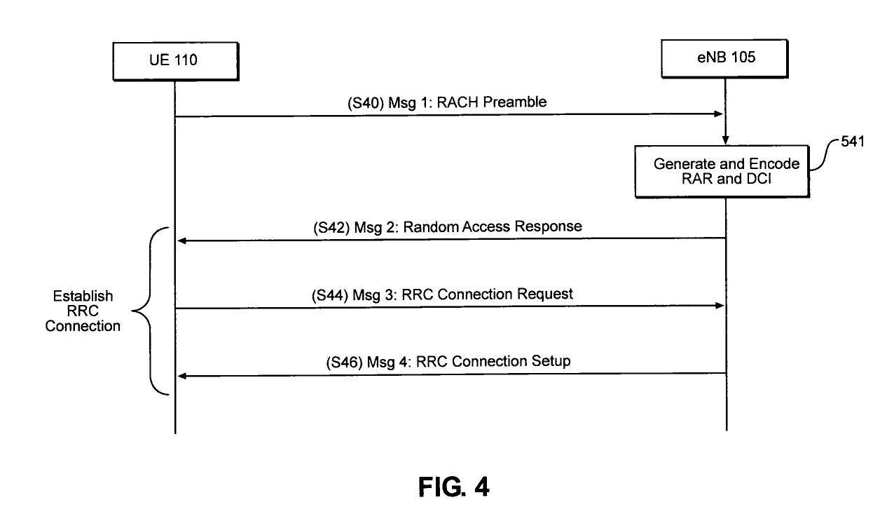

Still referring to FIG. 2, the scheduler 215 schedules control and data communications that are to be transmitted and received by the eNB 105 to and from UEs 110. Additional functionality of the scheduler 215 and the eNB 105 will be discussed in more detail later with regard to FIGS. 4-7.

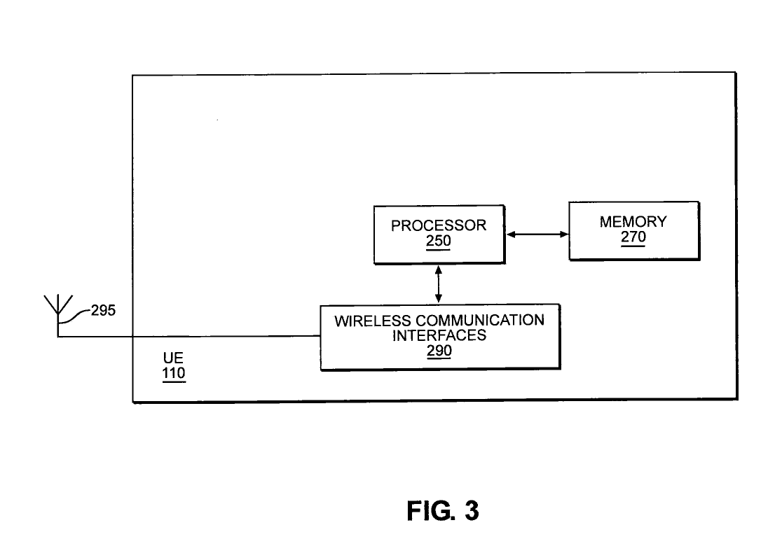

FIG. 3 illustrates an example of the UE 110 shown in FIG. 1.

Referring to FIG. 3, the UE 110 includes: a memory 270; a processor (or processing circuit) 250 connected to the memory 270; various interfaces 290 connected to the processor 250; and an antenna 295 connected to the various interfaces 290. The various interfaces 290 and the antenna 295 may constitute a transceiver for transmitting/receiving data from/to the eNB 105. As will be appreciated, depending on the implementation, the UE 110 may include many more components than those shown in FIG. 3. However, it is not necessary that all of these generally conventional components be shown in order to disclose the illustrative example embodiment.

The memory 270 may be a computer readable storage medium that generally includes a random access memory (RAM), read only memory (ROM), and/or a permanent mass storage device, such as a disk drive. The memory 270 also stores an operating system and any other routines/modules/applications for providing the functionalities of the UE 110 (e.g., functionalities of a UE, methods according to the example embodiments, etc.) to be executed by the processor 250. These software components may also be loaded from a separate computer readable storage medium into the memory 270 using a drive mechanism (not shown). Such separate computer readable storage medium may include a disc, tape, DVD/CD-ROM drive, memory card, or other like computer readable storage medium (not shown). In some embodiments, software components may be loaded into the memory 270 via one of the various interfaces 290, rather than via a computer readable storage medium.

The processor 250 may be configured to carry out instructions of a computer program by performing the arithmetical, logical, and input/output operations of the system. Instructions may be provided to the processor 250 by the memory 270.

The various interfaces 290 may include components that interface the processor 250 with the antenna 295, or other input/output components. As will be understood, the interfaces 290 and programs stored in the memory 270 to set forth the special purpose functionalities of the UE 110 will vary depending on the implementation of the UE 110.

When a UE (such as a UE 110 in FIG. 1) enters a coverage area of an eNB (such as the eNB 105 shown in FIG. 1), the UE attempts to establish a radio resource control (RRC) protocol connection (also referred to as a RRC connection) with the eNB to access the wireless network. As is known, the RRC protocol provides functions such as connection establishment and release functions, broadcast of system information, radio bearer establishment, reconfiguration and release, RRC connection mobility procedures, paging notification and release and outer loop power control. Through signaling functions, the RRC protocol configures the user and control planes according to status of the wireless network, and allows for implementation of Radio Resource Management strategies in the wireless network.

To initiate establishment of a RRC connection with the eNB, a UE sends a Random Access CHannel (RACH) preamble to the eNB in a first message (Msg1) via the Physical Random Access Channel (PRACH). As is known, the UE chooses the RACH preamble from among a set of 64 preamble sequences. The preamble sequence (or preamble ID) identifies the particular UE, including the type of UE and the identifier (UE ID) for the UE sending the preamble sequence. In one example, the preamble sequence may include a cyclic prefix, a sequence and a guard time. The preamble sequences may be defined from a Zadoff-Chu sequence.

In response to receiving the preamble ID from the UE on the PRACH, the eNB sends a Random Access Response (RAR) to the UE. The RAR for a particular UE may include a timing advance (TA) for the UE, a Cell Radio Network Temporary Identifier (C-RNTI) for the UE, and an uplink (UL) grant for the UE to transmit a subsequent RRC connection request to the eNB.

The RAR for the UE is multiplexed together with RARs for other UEs for which the eNB has received preamble IDs simultaneously, concurrently or within a given time window of the preamble ID from the UE. In this regard, the RARs for multiple UEs are multiplexed into RAR messages, wherein each of the RAR messages may include RARs for multiple different UEs.

Because the eNB is able to multiplex RARs for multiple different UEs in a single RAR message, the eNB also sends a control channel message corresponding to each RAR message to provide control information for decoding the PDSCH transmitted to a UE (e.g., transport block size (TBS) and modulation and coding scheme (MCS)) for decoding the RAR intended for a given UE).

The eNB sends the RAR to the UE in a given RAR message on the Physical Downlink Shared CHannel (PDSCH) along with the corresponding control channel message transmitted on a physical downlink control channel. As discussed herein, a RAR message may also be referred to as a RAR protocol data unit (PDU).

In one example, the eNB sends the control channel messages to the UEs on the Enhanced Physical Downlink Control CHannel (EPDCCH) in EPDCCH Common Search Space (CSS) subframes. The control channel messages are multiplexed with the RAR messages (e.g., in the time domain) for transmission to the UEs; that is, in this example the eNB multiplexes EPDCCH and PDSCH transmissions to the UEs such that the UEs receive a control channel message prior to receiving a corresponding RAR message.

Even if only 1 RAR is included in a RAR message, the eNB still provides the subband/physical resource block (PRB) for the resource information on the EPDCCH, unless the subband/PRB and the TBS and/or MCS is fixed in the specification or semi-statically configured in the system information blocks (SIB), which limits the scheduling flexibility at the eNB. In order to maintain the flexibility in scheduling RARs for UEs, the control channel messages are transmitted on the EPDCCH prior to transmission of the corresponding RAR message on the PDSCH. In a bandwidth limited system, the different repetition levels (even if different PRACH resources are used) may share the same subband for the control channel messages.

For a specific repetition level, the eNB must be able to respond to preamble IDs received from multiple different UEs (also referred to as PRACHs received from multiple different UEs) requesting access to the wireless network simultaneously, concurrently and/or within a given time window. Multiplexing of multiple RARs by the eNB may help in this respect. However, the eNB may also desire to spread uplink resources required for the Radio Resource Control (RRC) connection request messages from the UEs, rather than responding to all received PRACHs in one particular instance. To facilitate this spreading of uplink resources, 3GPP-LTE Release 8 (Rel-8), provides a random access (RA) response window in which the transmissions of RAR messages by the eNB are spread over a semi-statically configured period.

Conventionally, in this scenario, each UE decodes each control channel message transmitted on the EPDCCH as well as each corresponding RAR message transmitted on the PDSCH during the RA response window until the UE identifies its preamble ID in an RAR. In the case of a coverage enhanced (CE) LC-MTC UE, decoding a relatively large number of repetitions of the control channel and the PDSCH increases power consumption by the UE.

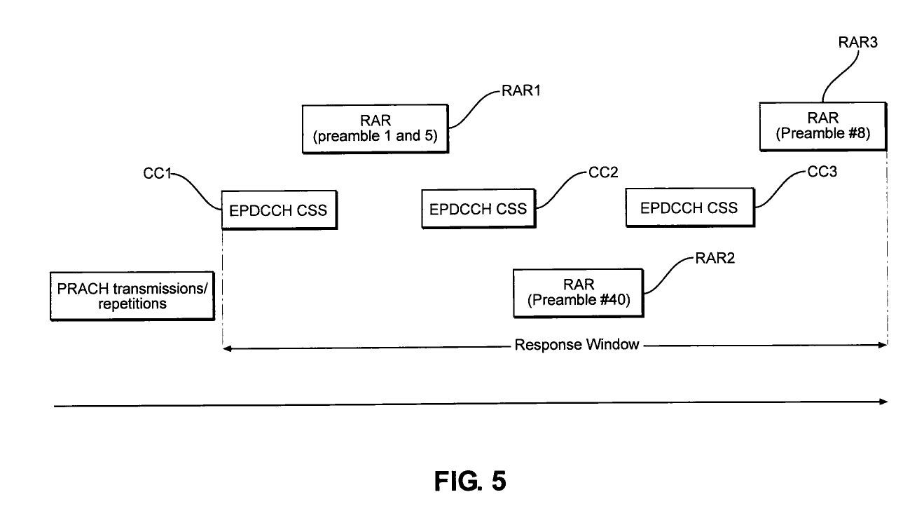

FIG. 5 illustrates example RACH transmissions for CE LC-MTC UEs. In this example, if the preamble ID sent by, for example, UE 110 shown in FIG. 1 is Preamble#8, then the UE 110 must decode three control channel messages CC1, CC2 and CC3 as well as three RAR messages RAR1, RAR2 and RAR3 in the RA response window even though only the RAR message RAR3 includes a RAR intended for the UE 110 (e.g., only RAR3 identifies Preamble#8 sent by UE 110).

One or more example embodiments allow for reduced power consumption at UEs (e.g., LC-MTC UEs) by providing indicator information as part of the control channel message transmitted to UEs on the physical downlink control channel (e.g., EPDCCH) preceding a corresponding RAR message transmitted on the downlink shared channel (e.g., PDSCH). As discussed in more detail below, the indicator information may be explicit or implicit in the control channel message, and indicates whether the corresponding RAR message includes a RAR intended for a particular UE. If the UE determines that the subsequent RAR message includes a RAR intended for the UE, then the UE processes and decodes the RAR message to obtain the RAR for the UE. Otherwise, the UE does not decode the corresponding RAR message. Example embodiments will be discussed in more detail below with regard to FIGS. 4, 6 and 7. Although example embodiments may be discussed herein with regard to the larger eNB and/or UE performing various functions, it should be understood that subcomponents of these larger devices may be performing the described functions. For example, if the eNB is described as transmitting or sending data, it should be understood that this function may also be characterized as being performed by a transceiver at the eNB.

FIG. 4 is a signal flow diagram illustrating an example embodiment of a method for establishing a radio resource control (RRC) connection between a UE and an eNB. For example purposes, the example embodiment shown in FIG. 4 will be discussed with regard to the UE 110 and the eNB 105 shown in FIGS. 1-3. However, example embodiments should not be limited to only this example.

Referring to FIG. 4, to initiate establishment of a RRC connection with the eNB 105, at S40 the UE 110 sends a RACH preamble (Msg1) to the eNB 105 via the PRACH.

In response to receiving the RACH preamble message (Msg1) from the UE 110, at S41 the scheduler 215 generates a RAR for the UE 110 to be transmitted to the UE 110 in a RAR message on the PDSCH. The scheduler 215 also generates downlink control information (DCI) for the RAR. As mentioned above, the RAR includes a timing advance (TA) for the UE, a Cell Radio Network Temporary Identifier (C-RNTI) for the UE, and an uplink (UL) grant for the UE to transmit a subsequent third message (e.g., Msg3, such as a RRC connection request) to the eNB 105. Because methods for generating RARs, and the information included therein, are well-known a detailed discussion is omitted.

The scheduler 215 encodes the RAR for transmission to the UE 110 in a RAR message on the PDSCH. The scheduler 215 also encodes the DCI for transmission to the UE 110 as a control channel message on the EPDCCH. Encoding of the DCI will be discussed in more detail later.

The DCI provides scheduling information for downlink transmissions on the PDSCH. Scheduling information may include resource assignments, such as which resource block pairs are used for a corresponding PDSCH transmission. Additionally, the DCI may provide scheduling information for uplink grant for the physical uplink shared channel (PUSCH). The DCI may also convey power control commands, Physical Multicast CHannel (PMCH) commands, and RACH commands.

According to one or more example embodiments, the encoded DCI may also serve as implicit indicator information indicating whether the corresponding RAR message transmitted on the PDSCH within the random access (RA) response window includes a RAR intended for the UE 110; that is, for example, whether the RAR message is intended for the UE 110.

In one example, the scheduler 215 may generate the implicit indicator information by encoding the DCI using a RA-RNTI that is a function of the preamble ID received from the UE on the PRACH. In other words, the scheduler 215 may implicitly indicate that a particular RAR message includes a RAR intended for the UE 110 by encoding the DCI information with a RA-RNTI that is a function of the preamble ID received from the UE 110. The DCI may be encoded by masking the DCI with the RA-RNTI. In one example, the RA-RNTI may be computed as a function of preamble ID using Equation (1) shown below.

RA-RNTI=1+t_{id}+10f_{id}+100*RAPID (1)

In Equation 1, RAPID is the preamble ID received from the UE 110, t_{id} is the time domain index of the first subframe in which the preamble ID is transmitted to the eNB 105, and f_{id} is the frequency domain index indicating the subcarrier group where the preamble ID is transmitted to the eNB 105. In at least this example, the time domain index is indicative of a subframe and has a value between 0 and 9.

In another example, the scheduler 215 generates the implicit indicator information by encoding the DCI using a RA-RNTI, which is a function of a value representing a set of a plurality of preamble IDs. In other words, the scheduler 215 may implicitly indicate that a particular RAR message includes a RAR intended for a UE by encoding the DCI information with a RA-RNTI that is a function of a value representing the set of a plurality of preamble IDs received from UEs simultaneously, concurrently or within a given time window. In an example case in which the set of preamble IDs is 2 (i.e., preamble IDs RAPID#A and RAPID#B), the RA-RNTI may be computed using a Cantor function as shown below in Equation (2).

RA-RNTI=½[RAPID_{A}+RAPID_{B}][RAPID_{A}+RAPID_{B}+1] (2)

According to one or more other example embodiments, the scheduler 215 may include explicit indicator information within the DCI itself. In this case, the DCI may still be encoded based on the RA-RNTI, but the RA-RNTI need not be a function of the preamble ID or a value representing a set of preamble IDs.

In one example, the explicit indicator information may be in the form of the multi-bit preamble ID received from the UE 110. In another example, the explicit indicator information may be a value representing a set of a plurality of preamble IDs associated with a set of a plurality of UEs. In this example, the preamble ID received from the UE 110 is included in the set of preamble IDs, and the explicit indicator may indicate that the corresponding RAR message includes RARs intended for each of the UEs associated with preamble IDs in the set of preamble IDs.

Returning now to FIG. 4, after generating and encoding the RAR and DCI at S41, at S42 the eNB 105 sends the encoded DCI and the RAR (Msg2) to the UE 110 within the RA response window. In one example, the eNB 105 sends the encoded DCI to the UE 110 in a control channel message on the EPDCCH. The eNB 105 transmits the RAR to the UE 110 in a RAR message on the PDSCH. The EPDCCH and PDSCH transmissions may be multiplexed (e.g., in the time domain) such that the UE 110 receives the control channel message prior to receiving the corresponding RAR message. The RAR for the UE 110 may be multiplexed (e.g., in time, frequency or code) with RARs for other UEs in the RAR message.

Upon receipt, the UE 110 examines the indicator information (either implicit or explicit) included in the control channel message to decide whether the corresponding RAR message includes a RAR intended for the UE 110.

Since, in this case, the RAR message corresponding to the decoded control channel message includes a RAR intended for the UE 110, the UE 110 decodes the corresponding RAR message to obtain the RAR provided by the eNB 105 for the UE 110.

Once having obtained the RAR included in the RAR message from the eNB 105, the UE 110 and the eNB 105 exchange RRC Connection messages to establish a RRC session between the UE 110 and the wireless network using the resources granted by the eNB 105 in the obtained RAR. In more detail, as shown in FIG. 4, at S44 the UE 110 sends a third message (e.g., Msg3, such as a RRC connection request message) to the eNB 105 using the resources granted to the UE 110 in the RAR intended for the UE 110.

In response to the RRC connection request message, at S46 the eNB 105 sends a fourth message (e.g., Msg4, such as a RRC connection setup message) to establish the RRC connection between the UE 110 and the eNB 105.

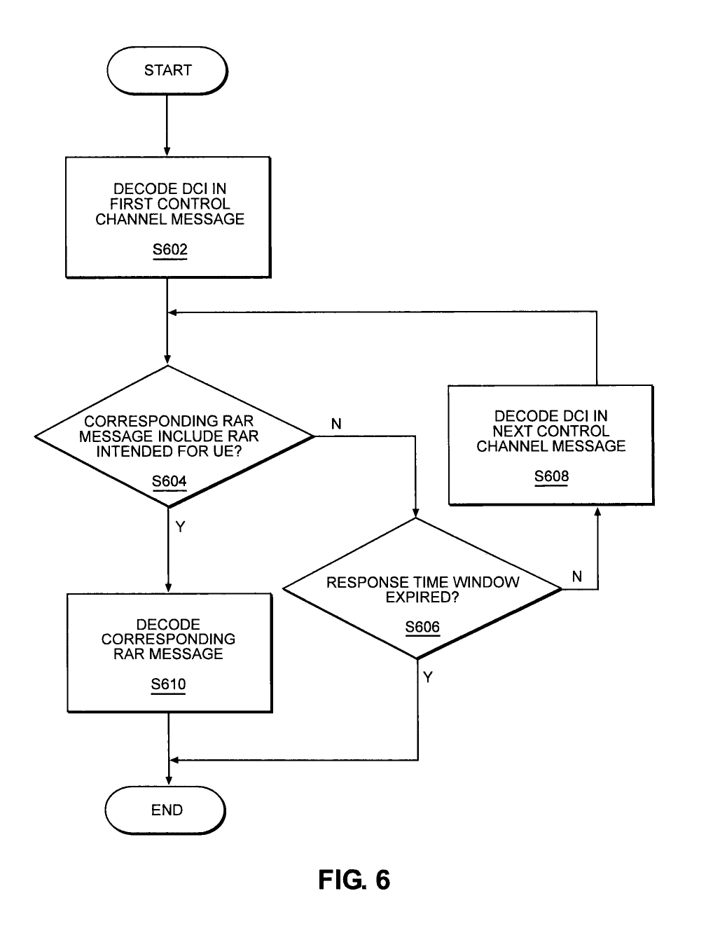

Example operation of the UE 110 will be discussed in more detail below with regard to FIG. 6.

FIG. 6 is a flow chart illustrating a method for processing RARs received from an eNB in a RA response window. For example purposes, the example embodiment shown in FIG. 6 will be discussed with regard to the eNB 105 and the UE 110. However, example embodiments should not be limited to this example. A UE may utilize the method shown in FIG. 6 during the RA response window to identify a RAR message including a RAR intended for the UE. Thus, in one example, the method shown in FIG. 6 may be performed prior to S43 and S44 in FIG. 4.

Referring to FIG. 6, at step S602 the processing circuit 250 decodes the DCI included in a first control channel message received during the RA response window.

At step S604, the processing circuit 250 of the UE decides whether the RAR message corresponding to the received control channel message includes a RAR intended for the UE 110 based on the decoded DCI.

In one example, the processing circuit 250 attempts to decode the DCI using the RA-RNTI for the UE 110. If the processing circuit 250 is able to properly decode the DCI using the RA-RNTI, then the UE 110 determines that the RAR message corresponding to the control channel message includes an RAR intended for the UE 110.

In another example, the processing circuit 250 decodes the DCI to obtain preamble information included in the DCI. In this example, the processing circuit 250 decodes the DCI based on RA-RNTI for the UE 110. If the preamble information includes the preamble ID generated by the UE 110, then the processing circuit 250 determines that the corresponding RAR message includes a RAR intended for the UE 110.

Example embodiments are discussed with regard to the DCI including preamble information, and the preamble information including a plurality of preamble IDs. However, in one or more other example embodiments, each DCI may include one preamble ID. In this example, the UE 110 decodes multiple DCIs and determines whether any of the multiple DCIs contains the preamble ID for the UE 110.

Returning to FIG. 6, if the processing circuit 250 of the UE decides that the corresponding RAR message does not include a RAR intended for the UE 110, then the processing circuit 250 determines whether the RA response time window has expired at step S606. The processing circuit 250 may determine whether the RA response window has expired using a counter (e.g., as discussed in the implementation of 3GPP LTE Rel-8. The value of the RA response window may be semi-statically configured using broadcast signaling, and begins at a fixed time after transmission of the preamble by the UE.

If the processing circuit 250 determines that the RA response window has not expired, then the processing circuit 250 decodes the DCI in a next control channel message at step S608. The processing circuit 250 decodes the DCI in the next control channel message in the same manner as discussed above with regard to step S602. The process then returns to step S604, and continues as discussed herein.

Returning to step S606, if the processing circuit 250 determines that the RA response time window has expired, then the process terminates without resulting in a RRC connection. In this case, the UE 110 performs retransmission of a preamble ID. In one example, the UE 110 may transmit a different preamble ID after expiration of backoff time window if a backoff indicator is provided by the eNB 105.

Returning to step S604 in FIG. 6, if the processing circuit 250 determines that the RAR message corresponding to the decoded control channel message includes a RAR intended for the UE 110, then at step S610 the UE 110 decodes the corresponding RAR message to obtain the RAR provided by the eNB 105 for the UE 110.

Once having obtained the RAR included in the RAR message from the eNB 105, the UE 110 and the eNB 105 exchange RRC Connection messages to establish a RRC session between the UE 110 and the wireless network using the resources granted by the eNB 105 in the obtained RAR, as discussed above with regard to FIG. 4.

In at least one other example embodiment, a preamble message (or part or PDU) may be transmitted to UEs along with the RAR message (or PDU) on the PDSCH. The preamble message may include preamble information including one or more preamble IDs for UEs to which the RAR message is intended.

In this example, the DCI included in the control channel message corresponding to the RAR message includes indicator information (either explicit or implicit) that indicates whether PDSCH is carrying the preamble message from the eNB; that is, whether the preamble message has been transmitted to the UE by the eNB on the PDSCH. Based on the DCI (and/or the indicator information contained therein), the user equipment is able to detect whether a preamble message is present on the PDSCH. In this example, the indicator information may be a 1-bit indicator (or flag bit) indicating whether a preamble message is present on the PDSCH. In this case, the RA-RNTI may be computed as RA-RNTI=1+t_{id}+10*f_{id}.

If the indicator information indicates that the preamble message is not present on the PDSCH, then the UE processes RAR messages in the conventional manner (e.g., sequentially decoding each RAR message until identifying the preamble ID associated with the UE).

If, however, the indicator information indicates that preamble message is present on the PDSCH, then the UE decides whether to decode the RAR message based on the preamble information included in the preamble message.

For example, the UE decodes the preamble message based on the DCI in the corresponding control channel message. If the preamble ID for the UE is included in the preamble message, then the UE decodes the RAR message associated with the preamble message. Otherwise, the UE does not decode the RAR message associated with the preamble message. This example embodiment is a compromise between the amount of multiplexing and the size of the RAR message (uplink grant and the temporary RNTI).

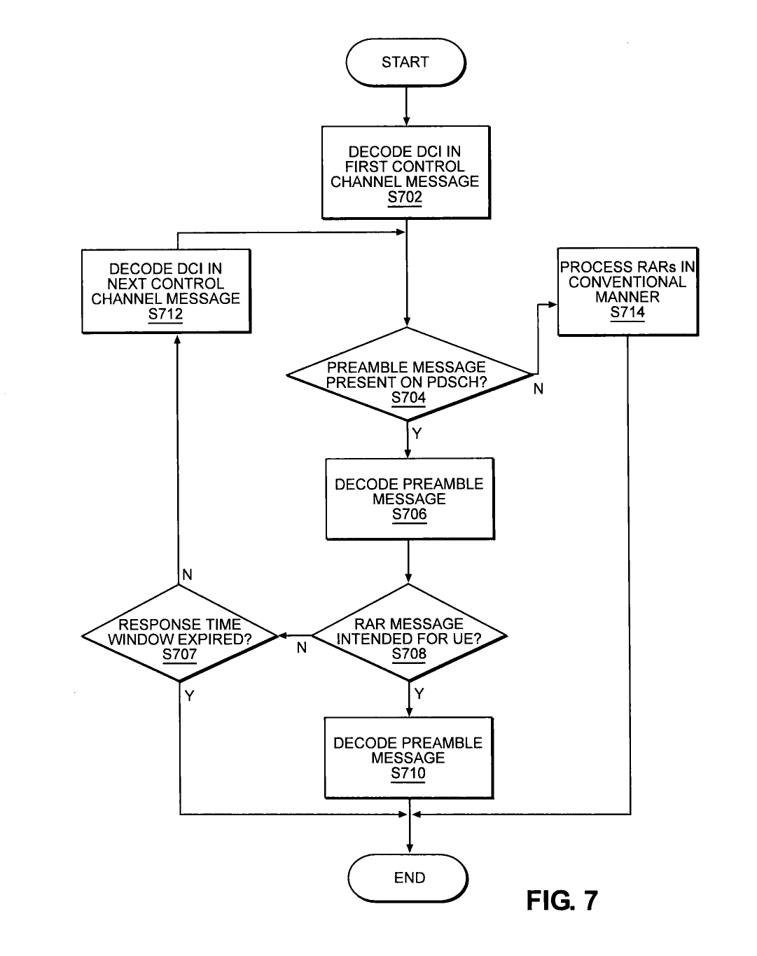

FIG. 7 is a flow chart illustrating another example embodiment of a method for processing RARs received from the eNB in a RA response window. In this example, the control channel message includes indicator information (either explicit or implicit) indicating whether the PDSCH from the eNB is carrying a preamble message corresponding to the RAR message. For example purposes, the example embodiment shown in FIG. 7 will again be described with regard to the UE 110 and the eNB 105. As with the example embodiment shown in FIG. 6, a UE may utilize the method shown in FIG. 7 during the RA response window to identify a RAR message including a RAR intended for the UE. Thus, in one example, the method shown in FIG. 7 may be performed prior to S43 and S44 in FIG. 4.

Referring to FIG. 7, at step S702 the processing circuit 250 decodes the DCI in the first control channel message. The processing circuit 250 may decode the DCI in the same manner as discussed above with regard to step S602 in FIG. 6.

At step S704, based on the decoded DCI, the processing circuit 250 determines whether a preamble message from the eNB 105 is present on the PDSCH along with the RAR message corresponding to the control channel message. In this example, the DCI may include an indicator bit (e.g., a flag bit) indicating whether the preamble message is present on the PDSCH.

If the processing circuit 250 determines that the preamble message is present on the PDSCH, then at step S706 the processing circuit 250 decodes the preamble message to determine whether the corresponding RAR message is intended for the UE 110 (e.g., includes an RAR for the UE 110). In one example, the UE 110 determines that the RAR message is intended for the UE 110 if the preamble message of the RAR message includes the preamble ID for the UE 110.

If the processing circuit 250 determines that the RAR message is intended for the UE 110 at step S708, then at step S710 the UE 110 decodes the corresponding RAR message (the RAR PDU) to obtain the RAR for the UE 110.

Returning to step S708, if the processing circuit 250 determines that the RAR message is not intended for the UE 110 based on the decoded preamble message, then the UE 110 does not decode the corresponding RAR message.

The processing circuit 250 then determines whether the RA response window has expired at step S707. If the processing circuit 250 determines that the RA response window has expired at S707, then the process terminates. In this case, the UE 110 performs retransmission of a preamble ID. In one example, the UE 110 may transmit a different preamble ID after expiration of backoff time window if a backoff indicator is provided by the eNB 105.

Returning to step S707, if the processing circuit 250 determines that the RA response window has not expired at step S707, then at step S712 the processing circuit 250 decodes the DCI in the next control channel message. The process then proceeds to step S704 and continues as discussed above.

Returning now to step S704 in FIG. 7, if the processing circuit 250 determines that the preamble message is not present on the PDSCH from the eNB 105, then at step S714 the processing circuit 250 proceeds by processing RAR messages received in the RA response window in the conventional manner; that is, the processing circuit decodes RAR messages received sequentially until identifying a RAR for the UE 110.

As with the example embodiment discussed above with regard to FIG. 6, once having obtained the resource information from the eNB 105, the UE 110 and the eNB 105 exchange third and fourth messages (e.g., Msg3 and Msg4, such as RRC Connection messages) to establish a RRC session between the UE 110 and the wireless network using the resources granted by the eNB 105 in the decoded RAR message.

The foregoing description of example embodiments has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A user equipment comprising:
a processing circuit configured to
determine whether to decode a random access response message received by the user equipment based on downlink control information received by the user equipment over a physical downlink control channel, the downlink control information one of implicitly and explicitly indicating whether the random access response message is intended for the user equipment, and
decode the random access response message to obtain a random access response for the user equipment if the downlink control information indicates that the random access response message is intended for the user equipment; and
a transceiver connected to the processing circuit and configured to establish a radio resource connection based on the obtained random access response.

2. The user equipment of claim 1, wherein the processing circuit is further configured to
attempt to decode the downlink control information based on a random access radio network temporary identifier associated with the user equipment; and
determine whether to decode the random access response message based on whether the attempt to decode the downlink control information is successful.

3. The user equipment of claim 2, wherein the random access radio network temporary identifier is a function of a preamble identifier associated with the user equipment.

4. The user equipment of claim 2, wherein the random access radio network temporary identifier is a function of a value representing a set of a plurality of preamble identifiers for a plurality of user equipments.

5. The user equipment of claim 1, wherein the processing circuit is further configured to
decode the downlink control information to obtain preamble information; and
determine whether the random access response message is intended for the user equipment based on the obtained preamble information.

6. The user equipment of claim 5, wherein the processing circuit is further configured to determine that the random access response message is intended for the user equipment if the obtained preamble information includes a preamble identifier for the user equipment.

7. The user equipment of claim 5, wherein
the preamble information includes a set of a plurality of preamble identifiers for a plurality of user equipments; and
the processing circuit is further configured to determine that the random access response message is intended for the user equipment if the set of the plurality of preamble identifiers includes a preamble identifier for the user equipment.

8. The user equipment of claim 5, wherein the processing circuit is configured to decode the downlink control information based on a random access radio network temporary identifier associated with the user equipment.

9. The user equipment of claim 8, wherein the downlink control information is masked with the random access radio network temporary identifier.

10. The user equipment of claim 5, wherein
the preamble information includes a multi-bit preamble identifier generated by the user equipment; and
the processing circuit is further configured to determine whether the random access response message is intended for the user equipment based on the multi-bit preamble identifier.

11. A user equipment comprising:
a processing circuit configured to
detect a preamble message on a physical downlink shared channel based on downlink control information received by the user equipment over a physical downlink control channel,
determine whether a random access response message on the physical downlink shared channel is intended for the user equipment based on the detected preamble message, and
decode the random access response message to obtain a random access response for the user equipment if the detected preamble message indicates that that the random access response message is intended for the user equipment; and
a transceiver connected to the processing circuit and configured to establish a radio resource connection based on the obtained random access response.

12. A base station comprising:
a transceiver configured to transmit downlink control information to a user equipment on a physical downlink control channel in response to preamble information received from the user equipment, the downlink control information being indicative of whether a random access response message transmitted to the user equipment on a physical downlink shared channel is intended for the user equipment, the transceiver being further configured to transmit the random access response message to the user equipment on the physical downlink shared channel.

13. The base station of claim 12, wherein the downlink control information indicates whether the random access response message is intended for the user equipment implicitly without providing a preamble identifier for the user equipment.

14. The base station of claim 12, further comprising:
a processing circuit including a scheduler configured to encode the downlink control information for transmission to the user equipment based on a random access radio network temporary identifier associated with the user equipment.

15. The base station of claim 14, wherein
the preamble information includes a preamble identifier for the user equipment; and
the random access radio network temporary identifier is a function of the preamble identifier for the user equipment.

16. The base station of claim 14, wherein the downlink control information is masked with the random access network temporary identifier without increasing the number of bits of the downlink control information.

17. The base station of claim 14, wherein the random access radio network temporary identifier is a function of a value representing a set of preamble identifiers associated with user equipments requesting access to the wireless network.

18. The base station of claim 12, wherein the downlink control information includes the preamble information received from the user equipment.

19. The base station of claim 18, wherein the preamble information includes a preamble identifier for the user equipment, the preamble identifier explicitly indicating to the user equipment that the random access response message is intended for the user equipment.

20. The base station of claim 18, wherein the preamble information includes a value representing a set of a plurality of preamble identifiers for user equipments attempting to access a wireless network, the set of the plurality of preamble identifiers explicitly indicating to the user equipment that the random access response message is intended for the user equipment.
